(19) United States
(12) Patent Application Publication
(10) Pub. No.: US 2026/0060884 A1
(43) Pub. Date: Mar. 5, 2026

(54) FASCIA GUN

(71) Applicant: SHENZHEN YOLANDA TECHNOLOGY CO., LTD., Shenzhen (CN)

(72) Inventors: Xiaohui SONG, Shenzhen (CN); Hongbin ZHU, Shenzhen (CN); Jun CAO, Shenzhen (CN)

(73) Assignee: SHENZHEN YOLANDA TECHNOLOGY CO., LTD., Shenzhen (CN)

(21) Appl. No.: 18/891,049

(22) Filed: Sep. 20, 2024

(30) Foreign Application Priority Data
Aug. 30, 2024 (CN) 202422133302.8

(51) Int. Cl. A61H 23/00; A61H 23/02

(52) U.S. Cl. CPC A61H 23/006; A61H 23/02; A61H 2201/0153; A61H 2201/1685; A61H 2201/5025

(57) ABSTRACT

A fascia gun includes a housing, a movement assembly, a massage head and a conduction component. When the massage head is separated from the piston, the trigger and the switch controller are spaced apart from each other, and the switch controller is configured to disconnect the anti-mistouch circuit of the main control board to limit the main control board from controlling the start of the driver. When the massage head is connected to the piston, the trigger is configured to trigger the switch controller to conduct the anti-mistouch circuit of the main control board to release the restriction of the main control board on the driver.

### CROSS-REFERENCE TO RELATED APPLICATIONS

This application claims priority to Chinese Patent Application No. 202422133302.8, filed on Aug. 30, 2024, the entire contents of which are incorporated herein by reference.

### TECHNICAL FIELD

The present application relates to the technical field of a fitness device, and in particular to a fascia gun.

### BACKGROUND

At present, the motor of the fascia gun on the market can usually start normally regardless of whether the massage head is pulled out or plugged into the piston. When the massage head is pulled out from the piston but not turned off, the motor movement will drive the piston to make high-frequency reciprocating motion. Most pistons are metal parts, so the high-frequency reciprocating motion of the piston without a massage head may cause great impact damage to the human body. Since the starting method is relatively random, if it is accidentally started by users, it may cause major accidents, such as physical disability. Since the accidental start-up poses risks to users, how to improve the safety of fascia guns has become an urgent problem to be solved.

### SUMMARY

The main purpose of the present application is to provide a fascia gun, aiming to solve the problem that the piston of the fascia gun may cause harm to the human body.

To achieve the above purpose, the present application provides a fascia gun, including: a housing; a movement assembly; a massage head and a conduction component. The housing has a receiving cavity and an opening communicated with the receiving cavity. The movement assembly includes a driver, a piston and a main control board. The driver is electrically connected to the main control board and is provided in the receiving cavity. The piston is connected to the driver. The main control board is configured to control the driver to start or stop, and the piston is movably provided at the opening. The massage head is detachably connected to the piston, and at least part of the massage head is disposed outside the housing. The conduction component includes a trigger and a switch controller. The trigger is provided on the massage head. The switch controller is provided on the piston, and the switch controller is connected to an anti-mistouch circuit of the main control board. When the massage head is separated from the piston, the trigger and the switch controller are spaced apart from each other, and the switch controller is configured to disconnect the anti-mistouch circuit of the main control board to limit the main control board from controlling the start of the driver. Or when the massage head is connected to the piston, the trigger is configured to trigger the switch controller to conduct the anti-mistouch circuit of the main control board to release the restriction of the main control board on the driver.

In an embodiment, the trigger is a conductive plate, and the switch controller is an elastic needle plate. The elastic needle plate includes a circuit board and at least two elastic needles. The elastic needles are provided on the circuit board at intervals, and at least two contact segments are provided on the conductive plate. When the massage head is connected to the piston, the contact segments are abutted against the elastic needles in a one-to-one correspondence to conduct the anti-mistouch circuit.

In an embodiment, the trigger is a magnetic member, and the switch controller is a hall element. When the massage head is connected to the piston, the magnetic member is close to the hall element. When the hall element senses a magnetic field of the magnetic member, the anti-mistouch circuit of the main control board is conducted.

In an embodiment, a slot is provided on one side of the piston facing the massage head, the switch controller is provided in the slot, the massage head includes a massage part and a connection part, the trigger is provided on a side of the connection part away from the massage part, and the connection part is plugged into the slot to make the trigger trigger the switch controller.

In an embodiment, the conduction component further includes a first bracket and a connecting wire, the first bracket is provided on a bottom wall of the slot, and the switch controller is provided on a side of the first bracket away from the bottom wall of the slot. One end of the connecting wire is connected to the switch controller, and another end of the connecting wire is configured to pass through the bottom wall of the slot and is connected to the main control board.

In an embodiment, a mounting groove is provided on one side of the connection part away from the massage part, and the trigger is provided in the mounting groove; and/or the massage head further includes a second bracket, the second bracket is provided in the mounting groove, and the trigger is provided on the second bracket and is provided toward the switch controller.

In an embodiment, the massage head further includes a silicone sleeve, a first limiting groove is provided on the connection part, the silicone sleeve is embedded in the first limiting groove, the silicone sleeve is abutted against an inner wall of the slot, and is at least partially sandwiched between a side wall of the limiting groove and an end face of the piston.

In an embodiment, the connection part is provided with an external thread, an inner wall of the slot is provided with an internal thread matching the external thread, and the massage head is threadedly connected to the piston.

In an embodiment, the massage head further includes a silicone ring. The connection part is provided with a second limiting groove spaced apart from the external thread. The silicone ring is embedded in the second limiting groove, and a side wall of the second limiting groove and the end face of the piston clamp the silicone ring.

In an embodiment, the movement assembly further includes a battery provided in the receiving cavity, and the driver includes a motor, an eccentric wheel and a bearing connecting rod. The battery is electrically connected to the motor and the main control board, and an output end of the motor is connected to the eccentric wheel. One end of the bearing connecting rod is rotatably connected to the eccentric wheel, and another end of the bearing connecting rod is rotatably connected to the piston.

In technical solutions of the present application, a conduction component is provided at the fascia gun to control the on and off of the anti-mistouch circuit on the main control board to control the driver to start or stop. The fascia gun includes a housing, a movement assembly, a massage head and a conduction component. A receiving cavity is formed in the housing and an opening connected to the receiving cavity is provided on the surface of the housing. The movement assembly includes a driver and a main control board provided in the receiving cavity and electrically connected to each other. The piston is movably provided at the opening and connected to the driver. The massage head is detachably connected to the piston. The conduction component includes a trigger and a switch controller. The trigger is provided on the massage head. The switch controller is correspondingly provided on the piston and connected to the anti-mistouch circuit of the main control board.

When the massage head is separated from the piston, the trigger and the switch controller are disconnected, and the switch controller is configured to disconnect the anti-mistouch circuit on the main control board. That is, the main control board is powered off and the driver cannot be started. At this time, the switch button of the fascia gun, the piston will not move when it is triggered. When the massage head is connected to the piston, the trigger is configured to trigger the switch controller, and the switch controller is configured to turn on the anti-mistouch circuit of the main control board, that is, the main control board is powered on. At this time, when the switch button of the fascia gun is pressed, the driver can be started, and the massage head is driven by the piston. By setting the conduction component, when the massage head is pulled out, the driver cannot be started even if the switch button is accidentally touched, and the piston cannot cause harm to the human body, which effectively improves the safety of the fascia gun and eliminates potential risks.

### BRIEF DESCRIPTION OF THE DRAWINGS

In order to more clearly illustrate the embodiments of the present application or the technical solutions in the related art, the drawings required for use in the embodiments or the description of the related art will be briefly introduced below. Obviously, the drawings described below are only some embodiments of the present application. For those skilled in the art other drawings can be obtained based on the structures shown in these drawings without creative work.

FIG. 1 is a schematic structural view of a disassembled structure of a fascia gun according to an embodiment of the present application.

FIG. 2 is a schematic structural view of an assembly structure of a massage head, piston, movement assembly and part of the housing of the fascia gun in FIG. 1.

FIG. 3 is an exploded view of the massage head, piston, conduction assembly and movement assembly according to an embodiment of the present application.

FIG. 4 is an assembled cross-sectional view of the massage head, piston, conduction assembly and movement assembly in FIG. 3.

FIG. 5 is an enlarged view of a conduction plate and an elastic needle plate according to an embodiment of the present application.

FIG. 6 is an exploded view of the massage head, piston, conduction assembly and movement assembly according to another embodiment of the present application.

FIG. 7 is an assembled cross-sectional view of the massage head, piston, conduction assembly and movement assembly in FIG. 6.

FIG. 8 is a schematic structural view of a disassembled structure of the massage head, piston, movement assembly and part of the housing according to an embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that if there is a directional indication (such as up, down, left, right, front, rear) in the embodiments of the present application, the directional indication is only used to explain the relative positional relationship, movement, etc. of the components in a certain posture (as shown in the drawings). If the specific posture changes, the directional indication will change accordingly.

Besides, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. The meaning of “and/or” appearing in the present application includes three parallel scenarios. For example, “A and/or B” includes only A, or only B, or both A and B. In addition, the technical solutions between the various embodiments can be combined with each other, but they must be based on the realization of those of ordinary skill in the art. When the combination of technical solutions is contradictory or cannot be achieved, it should be considered that such a combination of technical solutions does not exist, nor is it within the scope of the present application.

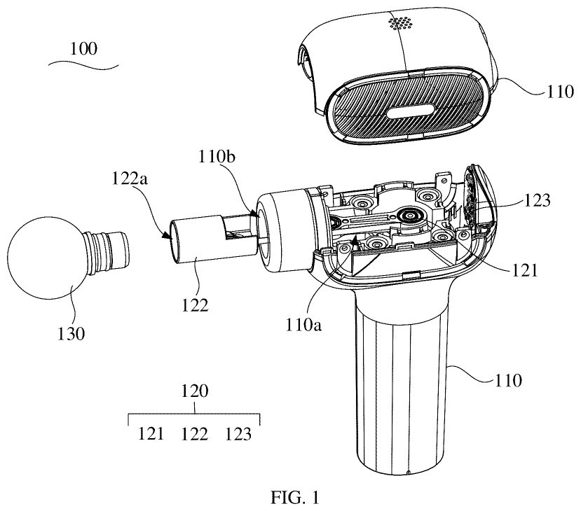

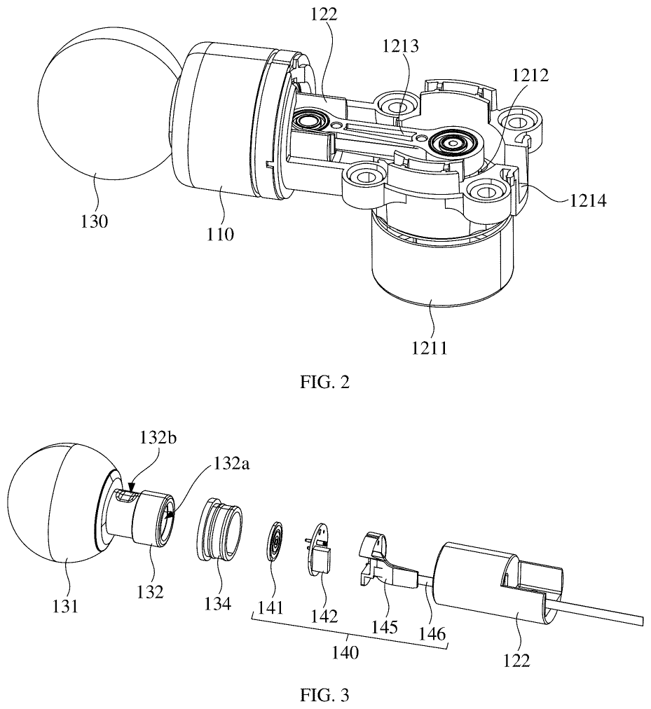

The present application provides a fascia gun, as shown in FIG. 1 to FIG. 7, in an embodiment, the fascia gun 100 includes a housing 110, a movement assembly 120, a massage head 130 and a conduction component 140. A receiving cavity 110a is formed in the housing 110 and an opening 110b communicated with the receiving cavity 110a, the opening 110b is provided on the surface of the housing 110. The movement assembly 120 includes a driver 121, a piston 122, and a main control board 123, the driver 121 and the main control board 123 are provided in the receiving cavity 110a and are electrically connected to each other. The piston 122 is movably provided at the opening 110b and is connected to the driver 121. The massage head 130 is detachably connected to the piston 122. The conduction component 140 includes a trigger and a switch controller. The trigger is provided on the massage head 130. The switch controller is correspondingly provided on the piston 122 and is connected to the anti-mistouch circuit of the main control board 123.

When the massage head 130 is separated from the piston 122, the trigger and the switch controller are disconnected, and the switch controller is configured to disconnect the anti-mistouch circuit of the main control board 123. That is, the main control board 123 is powered off and cannot start the driver 121. At this time, even if the switch button of the fascia gun 100 is accidentally touched, the piston 122 will not move. When the massage head 130 is connected to the piston 122, the trigger is configured to trigger the switch controller, and the switch controller is configured to conduct the anti-mistouch circuit of the main control board 123. That is, the main control board 123 is powered on. At this time, pressing the switch button of the fascia gun 100 can normally start the driver 121, and the piston 122 is configured to drive the massage head 130 to move. By setting the conduction component 140, when the fascia gun 100 is pulled out of the massage head 130, even if the switch button is accidentally touched, the driver 121 cannot be started, and the piston 122 cannot cause harm to the human body, which effectively improves the safety of the fascia gun 100 and eliminates potential risks.

In an embodiment, the trigger is a conductive plate 141, and the switch controller is an elastic needle plate 142. The elastic needle plate 142 includes a circuit board 1421 and at least two elastic needles 1422. The elastic needles 1422 are provided on the circuit board 1421 at intervals. At least two contact segments 1411 are provided on the conductive plate 141. When the massage head 130 is connected to the piston 122, the contact segments 1411 are abutted against the elastic needles 1422 in a one-to-one correspondence to conduct the anti-mistouch circuit.

As shown in FIG. 3 to FIG. 5, in an embodiment, the trigger is a conductive plate 141, and the switch controller is an elastic needle plate 142. The elastic needle plate 142 includes a circuit board 1421 and at least two elastic needles 1422. A plurality of elastic needles 1422 are provided at intervals on the circuit board 1421. A contact segment 1411 is provided on the conductive plate 141 corresponding to each elastic needle 1422. The plurality of elastic needles 1422 are respectively connected to the plurality of contact segments 1411 to form a loop, and the anti-mistouch circuit of the main control board 123 is turned on. The quantity of elastic needles 1422 can be three, and correspondingly, the quantity of contact segments 1411 can also be three. For example, one contact segment 1411 may be used as the central contact segment 1411, and the other two contact segments 1411 may be provided around the central contact segment, and each contact segment 1411 may abut against the elastic needles 1422 one by one. The elastic needle 1422 located at the center of the circuit board 1421 can be connected to the other two elastic needles 1422 through the conductive plate 141 to form a loop. Through such a setting, the elastic needle 1422 can be prevented from being disconnected from the contact segment 1411 when the massage head 130 is tilted. Setting a plurality of elastic needles 1422 can ensure the stability of the connection and prevent the fascia gun 100 from shutting down during use.

In an embodiment, the trigger is a magnetic member 143, and the switch controller is a hall element 144. When the massage head 130 is connected to the piston 122, the magnetic member 143 is close to the hall element 144, and when the hall element 144 senses the magnetic field of the magnetic member 143, the anti-mistouch circuit of the main control board 123 is conducted.

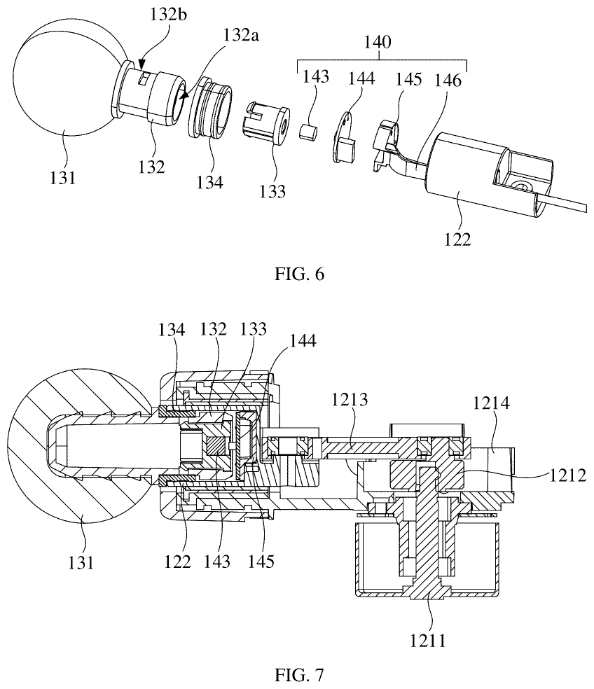

In an embodiment, as shown in FIG. 6 and FIG. 7, in an embodiment, the trigger provided on the massage head 130 is a magnetic member 143, and the switch controller is a hall element 144. The trigger can be a common magnet block, and the hall element 144 is provided on the piston 122. When the massage head 130 is connected to the piston 122, the hall element 144 senses the magnetic field of the magnetic member 143, and the anti-mistouch circuit of the main control board 123 is conducted. At this time, the massage head 130 of the fascia gun 100 is connected to the piston 122, the main control board 123 is powered on, and the driver 121 is started by pressing the switch button of the fascia gun 100. When the massage head 130 is pulled out of the piston 122, the switch controller cannot be configured to sense the magnetic field of the magnetic member 143, so the anti-mistouch circuit of the main control board 123 is disconnected, thereby preventing the user from accidentally touching the switch button to start the driver 121. The elastic needle 1422 is prone to breakage when the massage head 130 is tilted, and the magnetic member 143 and the hall element 144 are more stable than the elastic needle 1422. Both methods can achieve the anti-mistouch function, and the actual product can be set and selected according to specific needs.

In an embodiment, a slot 122a is provided on one side of the piston 122 facing the massage head 130, and the switch controller is provided in the slot 122a. The massage head 130 includes a massage part 131 and a connection part 132. The trigger is provided on a side of the connection part 132 away from the massage part 131. The connection part 132 is plugged into the slot 122a to make the trigger trigger the switch controller.

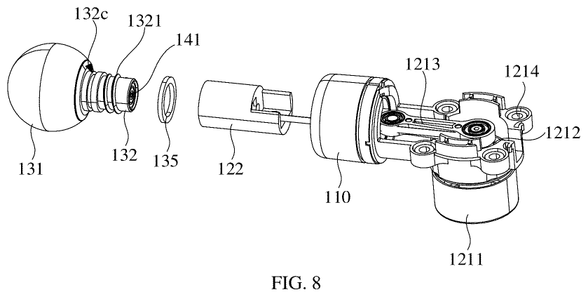

In an embodiment, as shown in FIG. 1 to FIG. 8, the end of the piston 122 facing the massage head 130 is provided with a slot 122a. The massage head 130 includes a massage part 131 and a connection part 132. The massage part 131 is configured to contact the human body to provide massage. One end of the connection part 132 is connected to the massage part 131, the trigger is provided on the side of the connection part 132 away from the massage head 130. The switch controller is provided in the slot 122a of the piston 122. When the connection part 132 is plugged into the slot 122a of the piston 122, the trigger can be configured to trigger the switch controller to turn on the anti-mistouch circuit of the main control board 123. By providing the slot 122a on the piston 122, the installation of the switch controller and the plugging of the massage head 130 can be facilitated. The slot 122a can be configured to constrain the insertion direction of the connection part 132, so that the trigger and the switch controller can be accurately docked.

In an embodiment, the conductive component 140 also includes a first bracket 145 and a connecting wire 146. The first bracket 145 is provided on the bottom wall of the slot 122a. The switch controller is provided on the side of the first bracket 145 away from the bottom wall of the slot 122a. One end of the connecting wire 146 is connected to the switch controller, and another end of the connecting wire 146 is configured to pass through the bottom wall of the slot 122a and is connected to the main control board 123.

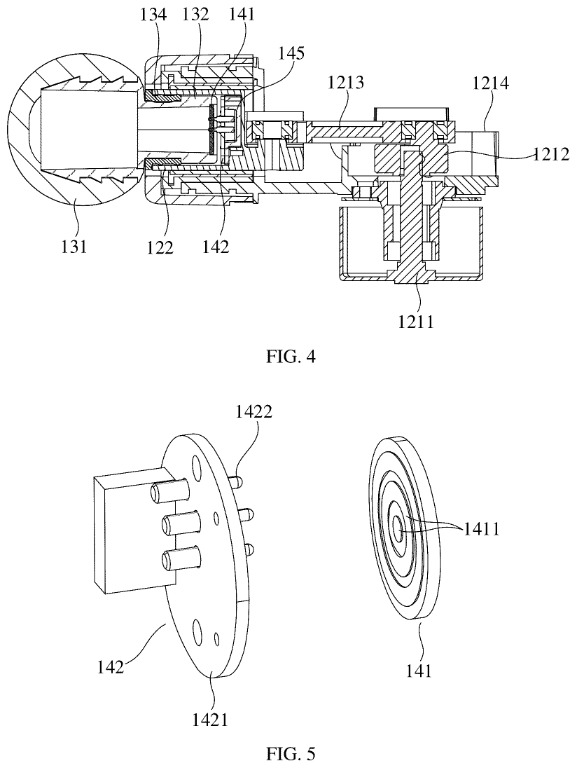

In an embodiment, as shown in FIG. 3, FIG. 4, FIG. 6 and FIG. 7, the conduction component 140 further includes a first bracket 145 and a connecting wire 146. The first bracket 145 is provided on the bottom wall of the slot 122a, and the switch controller is provided on the side of the first bracket 145 away from the bottom wall of the slot 122a. When the connection part 132 of the massage head 130 is plugged into the slot 122a, the trigger can be configured to trigger the switch controller on the first bracket 145. One end of the connecting wire 146 is connected to the switch controller. A through hole is provided through the bottom wall of the slot 122a. Another end of the connecting wire 146 is configured to pass through the through hole and connects to the main control board 123 in the receiving cavity 110a. The connecting wire 146 can be a bending-resistant cable with a margin in length, so that the connecting wire 146 can be repeatedly bent and extended when the piston 122 moves at a high frequency, thereby ensuring the stability of the connection.

In an embodiment, a mounting groove 132a is provided on one side of the connecting part 132 away from the massage part 131, and the trigger is provided in the mounting groove 132a; and/or, the massage head 130 further includes a second bracket 133, the second bracket 133 is provided in the mounting groove 132a, and the trigger is provided on the second bracket 133 and is provided toward the switch controller.

In an embodiment, as shown in FIG. 3, FIG. 4, FIG. 6 and FIG. 7, a mounting groove 132a is provided on the side of the connection part 132 of the massage head 130 away from the massage part 131, and the mounting groove 132a is used for installing a trigger. Placing the trigger in the mounting groove 132a can reduce the occupation of the slot 122a by the connection part 132, thereby reducing the overall length of the piston 122 and reducing the overall volume of the fascia gun 100. In addition, arranging the trigger in the mounting groove 132a can improve the compactness of the internal components of the fascia gun 100, thereby improving space utilization and reducing the difficulty of assembling the components of the fascia gun 100.

In an embodiment, the massage head 130 also includes a second bracket 133. As shown in FIG. 6 and FIG. 7, a buckle is provided on the second bracket 133. A slot is provided on the connection part 132. The magnetic member 143 is fixed on the second bracket 133 and the buckle of the second bracket 133 is plugged into the slot of the connection part 132. The second bracket 133 is fixed to the end of the connection part 132 away from the massage head 130, so that the hall element 144 can be located in the magnetic field of the magnetic member 143. The shape of the bracket may correspond to the shape of the conducting plate 141, so as to fix the conduction plate 141 on the connection part 132, which is not specifically limited here.

In an embodiment, the massage head 130 also includes a silicone sleeve 134. A first limiting groove 132b is provided on the connection part 132. The silicone sleeve 134 is embedded in the first limiting groove 132b. The silicone sleeve 134 is abutted against the inner wall of the slot 122a and is at least partially sandwiched between the side wall of the limiting groove and the end face of the piston 122.

In an embodiment, as shown in FIG. 3 and FIG. 6, the massage head 130 also includes a silicone sleeve 134. The connection part 132 of the massage head 130 is cylindrical and has a first limiting groove 132b on its outer surface. The slot 122a of the piston 122 is a circular groove. The silicone sleeve 134 is embedded in the first limiting groove 132b. When the connection part 132 is plugged into the slot 122a, the outer surface of the silicone sleeve 134 is interference fit with the inner wall of the slot 122a, thereby improving the tightness of the connection between the massage head 130 and the piston 122.

In an embodiment, the end of the silicone sleeve 134 close to the massage head 130 is configured to extend in a direction away from the connection part 132 to form an annular step portion. One side of the step portion is abutted against the side wall of the first limiting groove 132b, and another side of the step portion is abutted against the end face of the piston 122. That is, the side wall of the first limiting groove 132b and the end face of the piston 122 clamp the step portion of the silicone sleeve 134 to prevent the end face of the piston 122 from contacting with the massage head 130 and causing wear, while preventing the silicone sleeve 134 from moving along the axial direction of the connection part 132 to affect the stability of the connection. The silicone sleeve 134 also has a waterproof function to protect the conductive component 140 inside the piston 122.

In an embodiment, the connection part 132 is provided with an external thread 1321, and the inner wall of the slot 122a is provided with an internal thread matching the external thread 1321, and the massage head 130 is threadedly connected to the piston 122.

In an embodiment, as shown in FIG. 7, an external thread 1321 is provided on the outer surface of the connection part 132, and an internal thread (not shown) is correspondingly provided on the inner wall of the slot 122a of the piston 122. The connection part 132 is screwed into the slot 122a to thread the massage head 130 and the piston 122. It can be understood that the use of a threaded connection can improve the tightness of the connection. Since the outer surface of the silicone sleeve 134 is interference fit with the inner wall of the slot 122a, after long-term use or repeated plugging and unplugging, the silicone fatigues and loses its elasticity, causing the massage head 130 to loosen, affecting the user's use. The threaded connection are more stable and less likely to loosen.

In an embodiment, the massage head 130 also includes a silicone ring 135. The connection part 132 is provided with a second limiting groove 132c spaced apart from the external thread 1321. The silicone ring 135 is embedded in the second limiting groove 132c, and the side wall of the second limiting groove 132c and the end face of the piston 122 clamp the silicone ring 135.

In an embodiment, as shown in FIG. 7, in order to improve the effect of the threaded connection, the massage head 130 also includes a silicone ring 135. A second annular limiting groove 132c is provided on the connecting part 132. The silicone ring 135 is embedded in the second limiting groove 132c. The side wall of the second limiting groove 132c abuts against one side of the silicone ring 135. When the connecting part 132 is screwed into the slot 122a, the end face of the piston 122 abuts against the other side of the silicone ring 135 to elastically deform the silicone ring 135. The elastic force generated by the elastic deformation of the silicone ring 135 causes the external thread 1321 to bite the internal thread of the piston 122 to prevent the massage head 130 from loosening, thereby effectively improving the fastening effect of the massage head 130 and enhancing the user experience.

In an embodiment, the movement assembly 120 also includes a battery provided in the receiving chamber 110a, the driver 121 includes a motor 1211, an eccentric wheel 1212 and a bearing connecting rod 1213, the battery is electrically connected to the motor 1211 and the main control board 123, the output end of the motor 1211 is connected to the eccentric wheel 1212, one end of the bearing connecting rod 1213 is rotatably connected to the eccentric wheel 1212, and another end of the bearing connecting rod 1213 is rotatably connected to the piston 122.

In an embodiment, the movement assembly 120 also includes a battery (not shown), the driver 121 includes a motor 1211, an eccentric wheel 1212, a bearing connecting rod 1213 and a motor bracket 1214, the motor bracket 1214 is fixed in the receiving cavity 110a, the motor 1211 is provided on the motor bracket 1214 and the output end is connected to the eccentric wheel 1212, one end of the bearing connecting rod 1213 is rotatably connected to the eccentric wheel 1212, and another end of the bearing connecting rod 1213 is rotatably connected to the end of the piston 122 away from the massage head 130, and the battery is provided inside the receiving cavity 110a and below the motor 1211, the motor 1211 is electrically connected to the battery through the main control board 123. The main control board 123 is configured to control the rotation of the motor 1211 and transmit power to the piston 122 through the eccentric wheel 1212 and the bearing connecting rod 1213. A bushing assembly is provided on the outer surface of the piston 122 to constrain the movement direction of the piston 122. The bearing connecting rod 1213 is configured to drive the piston 122 and the massage head 130 to perform high-frequency reciprocating motion along the axial direction of the bushing assembly to massage human.

The above contents are only some embodiments of the present application, and do not limit the scope of the present application. All equivalent structural changes made by using the contents of the present application specification and drawings under the inventive concept of the present application, or directly/indirectly applied in other related technical fields are included in the scope of the present application.

What is claimed is:

1. A fascia gun, comprising:
a housing;
a movement assembly;
a massage head; and
a conduction component, wherein:
the housing has a receiving cavity and an opening communicated with the receiving cavity;
the movement assembly comprises a driver, a piston and a main control board, the driver is electrically connected to the main control board and is provided in the receiving cavity, the piston is connected to the driver, the main control board is configured to control the driver to start or stop, and the piston is movably provided at the opening;
the massage head is detachably connected to the piston, and at least part of the massage head is disposed outside the housing;
the conduction component comprises a trigger and a switch controller, the trigger is provided on the massage head, the switch controller is provided on the piston, and the switch controller is connected to an anti-mistouch circuit of the main control board;
when the massage head is separated from the piston, the trigger and the switch controller are spaced apart from each other, and the switch controller is configured to disconnect the anti-mistouch circuit of the main control board to limit the main control board from controlling the start of the driver; or
when the massage head is connected to the piston, the trigger is configured to trigger the switch controller to conduct the anti-mistouch circuit of the main control board to release the restriction of the main control board on the driver.

2. The fascia gun of claim 1, wherein:
the trigger is a conductive plate, and the switch controller is an elastic needle plate;
the elastic needle plate comprises a circuit board and at least two elastic needles, the elastic needles are provided on the circuit board at intervals, and at least two contact segments are provided on the conductive plate; and
when the massage head is connected to the piston, the contact segments are abutted against the elastic needles in a one-to-one correspondence to conduct the anti-mistouch circuit.

3. The fascia gun of claim 1, wherein:
the trigger is a magnetic member, and the switch controller is a hall element;
when the massage head is connected to the piston, the magnetic member is close to the hall element; and
when the hall element senses a magnetic field of the magnetic member, the anti-mistouch circuit of the main control board is conducted.

4. The fascia gun of claim 3, wherein a slot is provided on one side of the piston facing the massage head, the switch controller is provided in the slot, the massage head comprises a massage part and a connection part, the trigger is provided on a side of the connection part away from the massage part, and the connection part is plugged into the slot to make the trigger trigger the switch controller.

5. The fascia gun of claim 4, wherein:
the conduction component further comprises a first bracket and a connecting wire, the first bracket is provided on a bottom wall of the slot, and the switch controller is provided on a side of the first bracket away from the bottom wall of the slot; and
one end of the connecting wire is connected to the switch controller, and another end of the connecting wire is configured to pass through the bottom wall of the slot and is connected to the main control board.

6. The fascia gun of claim 5, wherein:
a mounting groove is provided on one side of the connection part away from the massage part, and the trigger is provided in the mounting groove; and/or
the massage head further comprises a second bracket, the second bracket is provided in the mounting groove, and the trigger is provided on the second bracket and is provided toward the switch controller.

7. The fascia gun of claim 4, wherein the massage head further comprises a silicone sleeve, a first limiting groove is provided on the connection part, the silicone sleeve is embedded in the first limiting groove, the silicone sleeve is abutted against an inner wall of the slot, and is at least partially sandwiched between a side wall of the limiting groove and an end face of the piston.

8. The fascia gun of claim 4, wherein the connection part is provided with an external thread, an inner wall of the slot is provided with an internal thread matching the external thread, and the massage head is threadedly connected to the piston.

9. The fascia gun of claim 8, wherein:
the massage head further comprises a silicone ring, the connection part is provided with a second limiting groove spaced apart from the external thread; and
the silicone ring is embedded in the second limiting groove, and a side wall of the second limiting groove and the end face of the piston clamp the silicone ring.

10. The fascia gun of claim 1, wherein:
the movement assembly further comprises a battery provided in the receiving cavity, and the driver comprises a motor, an eccentric wheel and a bearing connecting rod;
the battery is electrically connected to the motor and the main control board, and an output end of the motor is connected to the eccentric wheel; and
one end of the bearing connecting rod is rotatably connected to the eccentric wheel, and another end of the bearing connecting rod is rotatably connected to the piston.
